(19) United States
(12) Patent Application Publication
(10) Pub. No.: US 2012/0168456 A1
(43) Pub. Date: Jul. 5, 2012

(54) POP-UP LABEL DISPENSER AND METHOD OF USE

(75) Inventor: James E. NASH, Bloomington, MN (US)

(73) Assignee: 3M Innovative Properties Company

(21) Appl. No.: 12/980,761

(22) Filed: Dec. 29, 2010

(51) Int. Cl. B65G 59/02; B65D 83/08

(52) U.S. Cl. 221/1; 221/282; 221/208

(57) ABSTRACT

A label dispenser assembly for individually dispensing labels from a pad is disclosed. The label dispenser assembly includes rotatably accommodated retention members urged towards a surface of the dispenser for securing a pad of labels in place.

### FIELD

This invention relates to pop-up dispensers for labels, particularly stacks or pads of tabbed labels, and a method for dispensing such labels.

### BACKGROUND

Adhesive-back linerless labels and assemblies for dispensing individual labels from pads or stacks have been used in several applications. For example, US Patent Application Publication No. 2010/0116425 A1 describes a linerless stack of adhesive labels with non-adhesive, removable tabs that may be dispensed from a stack or pad configuration. U.S. application Ser. No. 12/775,327 describes a dispenser for individually dispensing adhesive-backed tabbed labels. The dispenser includes a pair of wing sections forming a take-out opening therebetween, and thus forming an approximately flat C-shaped configuration. The dispenser accommodates a linerless stack of tabbed labels that are separably adhered to each other in zigzag orientation. The labels are removed from the take-out opening one by one.

There remains a need for a label dispenser which provides improved performance, for example, that is more effective at individually dispensing labels from a pad without damaging the labels, that can be easily operated by hand, and that has desirable aesthetic characteristics.

### SUMMARY

The present invention provides a label dispenser apparatus and assembly for individually dispensing tabbed linerless, adhesive-backed labels from a pad and also provides a method of dispensing tabbed labels. The invention is well suited for use with linerless stacks or pads of tabbed labels.

In brief summary, the label dispenser apparatus of the invention includes a support surface having first and second remote ends, first and second retention members rotatably accommodated at the first and second remote ends so as to define a dispensing channel therebetween, each having a contact edge, and first and second tensioning mechanisms. The contact edges of the first and second retention members are urged towards the support surface by the first and second tensioning mechanisms, respectively, such that the contact edges of the first and second retention member each exerts a force towards the support surface, e.g., so as to retain securely a pad of labels in the assembly.

The label dispenser apparatus of the invention is configured for use with a pad of labels accommodated, i.e., operationally seated, on the support surface such that the first and second retention members exert a force on the pad of labels towards the support surface; such combinations being referred to as label dispenser assemblies herein. In an exemplary embodiment, the tab portion of the topmost label extends through the dispensing channel and rests above or adjacent to the first retention member and the first retention member exerts force on the main portion of the underlying label.

Briefly summarizing, the present invention provides a method of dispensing a label, including the steps of: (1) providing a label dispenser assembly as described herein, the assembly comprising a label dispenser apparatus and a pad of tabbed linerless, adhesive-backed labels operationally seated therein; (2) gripping (e.g., by hand) the tab portion of the topmost label; and (3) pulling (e.g., by hand) the tab portion of the topmost label in a direction away from the label dispenser assembly through the dispensing channel such that the topmost label is removed from beneath the first retention member, the tab portion of the underlying label is removed from beneath the first retention member, and the topmost label is separated from the label dispenser assembly. In an exemplary embodiment, the contact edge of the first retention member rotates away from the first surface when the topmost label is removed from beneath the first retention member and then under impetus of the tensioning mechanism rotates back into position to secure the remaining labels in the pad with the tab portion of the next label, formerly the underlying label now the top most label, protruding through the dispensing channel in position to be gripped in turn. Thus the invention provides what is sometimes referred to as “pop-up” operation.

The invention provides a label dispenser apparatus and assembly which provides improved performance, including effective individually dispensing of labels from a pad without damaging the labels, easy operation by hand, easy reloading, and, if desired, pleasing aesthetic characteristics.

### BRIEF DESCRIPTION OF THE DRAWINGS

The invention may be more completely understood in consideration of the following detailed description of various embodiments of the invention in connection with the accompanying drawings, in which:

FIG. 1 is a cross sectional view of an exemplary embodiment of a pad of labels for use with the present invention.

FIG. 2 is a perspective view of an exemplary embodiment of a label dispenser apparatus according to the present invention.

FIG. 3 is a perspective view of a portion of the underside of an exemplary embodiment of a label dispenser apparatus according to the present invention.

FIG. 4 is a perspective view of an exemplary embodiment of a label dispenser assembly with a pad of labels operationally seated therein according to the present invention.

FIG. 5 is a perspective sectional view of an exemplary embodiment of a label dispenser assembly with a pad of labels operationally seated therein according to the present invention.

FIG. 6 is a perspective view of an exemplary embodiment of a label dispenser apparatus according to the present invention.

The figures are not to scale. Like numbers used in the figures refer to like components. However, it will be understood that the use of a number to refer to a component in a given figure is not intended to limit the component in another figure labeled with the same number.

### DETAILED DESCRIPTION OF ILLUSTRATIVE EMBODIMENTS

In the following description, reference is made to the accompanying drawings that form a part of this description, and in which are shown by way of illustrating several specific embodiments. It is to be understood that other embodiments are contemplated and may be made without departing from the scope or spirit of the present invention.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise. For purposes of clarity and without intending to be unduly limited thereby, the labels in a group of any two sequentially stacked labels in a pad are referenced as an overlying label and an underlying label with the adhesive of the overlying label adhered to front face of the underlying label.

The present invention provides a label dispenser assembly for individually dispensing labels from a pad operationally seated in the dispenser assembly. In an exemplary embodiment, a pad of labels for use in the present invention includes a plurality of linerless labels. Each label includes a first major face and a second major face and adhesive, typically in a substantially continuous layer, on at least a portion, but in most embodiments not all of, the second major face. The labels are disposed in a stack with the adhesive layer of each label engaging the first major face of the underlying label in the stack. Each label includes a main portion and a tab portion. The main portion is typically substantially completely covered with adhesive on its second major face and the tab portion has little, if any, adhesive on its second major face. The main portion and tab portion of each label are preferably separated by a weakened separation line by which a user may easily separate and remove the tab portion after adhering the main portion to a substrate as desired. In an exemplary embodiment, the pad of labels comprises a stiff backcard beneath the bottommost label which may be used to facilitate storage and handling of the pad of labels as well as operationally seating the pad in the apparatus. In some embodiments, the pad of labels may be removeably adhered to the support surface of the label dispenser assembly of desired.

As used herein, the term “tabbed labels” refers to labels arranged in a stacked pad wherein a portion of the top most label is free from the underlying label configured to be grasped by hand to remove the top most label from the underlying label. The tabbed portion may be provided by, for instance: (1) configuring the top most label to have an edge portion which does not have adhesive on its underside, (2) configuring the top most label to have a release liner covering the adhesive on its underside near an edge portion, or (3) providing a release agent on a corresponding edge portion of the underlying label to provide differential release of the top most label therefrom. As used herein, the term “linerless stack” or “linerless pad” refers to a stack of labels arranged one on top of another with the adhesive on the bottom side of an overlying label in contact with the front face of the next or underlying label and so forth.

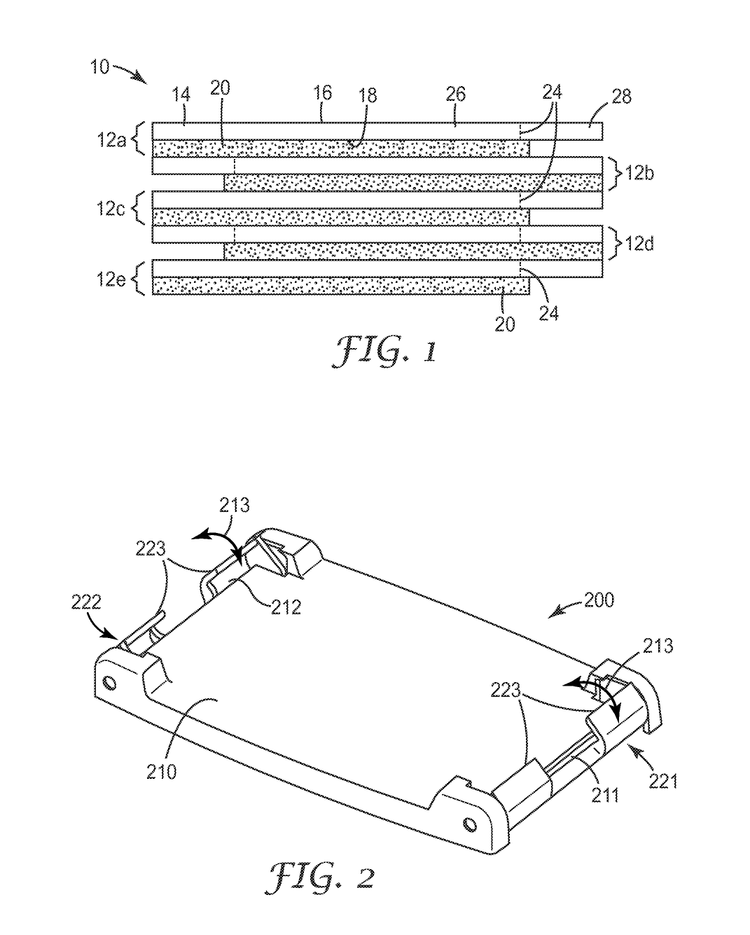

An exemplary embodiment of a pad of labels according to the present invention is illustrated in FIG. 1. A pad of labels 10 includes a plurality of labels 12a, 12b, 12c, 12d, and 12e. Each label includes a sheet 14 having a first major face 16 and a second major face 18 and a layer of adhesive 20 on a portion, but not all, of the second major face 18. The labels are disposed in a stack with the adhesive layer 20 of each label engaging the first major face of the underlying label in the stack, and, in the case of the bottommost label (not shown), engaging a release liner, stiff backing sheet, etc. or a support surface of the label dispenser assembly. The adhesive layer of each sheet 14 adheres more strongly to the second major face 18 of the sheet than it does to the first major surface of the underlying label. When the topmost label is removed, the adhesive preferably leaves substantially no residue on the first major face of the underlying label.

In an exemplary embodiment, each sheet in a pad of labels 10 may have a weakened separation line 24 that divides the sheet into a main portion 26 and a tab portion 28. The separation line is typically positioned substantially parallel to the boundary of the portion of the sheet that is coated with the adhesive layer 20 and the portion of the sheet that is not coated with the adhesive. In many embodiments the separation line and boundary of the adhesive coverage will be substantially linear, although it will be understood that other configurations may be used in accordance with the invention if desired. In order to ensure that the entirety of the bottom surface of the main portion is coated with adhesive such that the label exhibits the desired bond performance without undesirable edge lift, the weakened separation line may be positioned just inside the boundary of the adhesive coating. That is, a minor portion of the second major face of the tab portion adjacent the main portion is coated with adhesive while a larger portion located away from the separation line is uncoated with adhesive. The portion of the tab portion of the label that is uncoated with adhesive is typically larger than the portion of the tab portion which is coated with adhesive. In some embodiments, it is suitable to position the weakened separation line at a position of up to about 2 millimeters into the portion of the sheet that is coated with adhesive. If the weakened separation line is positioned too deeply into the adhesive coated portion, performance may be undesirably impaired. For example, the tab portions may not separate easily from underlying labels impairing desired “pop-up” performance in apparatuses of the invention and/or tab portions may adhere undesirably to substrates to which labels are adhered. If the weakened separation line is positioned too far into the uncoated area, leaving a portion of the main portion of the label without underlying adhesive, then the label may fail to adhere desirably to a substrate as the subject edge of the label is liable to edge picking, debris and dirt capture, etc. In other embodiments, the separation line is coextensive with the adhesive coverage, i.e., substantially all of the tab portion is free of adhesive and substantially all of the second face of the main portion is covered by adhesive.

The weakened separation line may be formed by any suitable means. For example, the weakened separation line may be formed by a perforation line with a series of cuts and ties, one or more slits penetrating partially through the label, or the like. The separation line may be substantially straight or may be curved. In an exemplary embodiment, the separation line is created such that the label will have a substantially smooth edge. A smooth edge can be accomplished, for example, by the use of fine ties if a perforation line is used, and sufficiently deep slit, if the weakened separation line is a slit. The weakened separation line should not be so weak that the label cannot be removed from the stack as desired. That is, the weakened separation line must be of sufficient strength that a label can be removed from the label dispenser assembly without the tab portion separating from the label, but sufficiently weak that subsequent separation of the tab portion may be easily achieved by, for example, folding at the weakened separation line and tearing.

The labels are typically arranged in alternating orientation such that the tab portions of successive labels in the stack are positioned on alternating sides of the stack (sometimes referred to as a “Z-stack” arrangement). The labels in any group of three sequentially stacked labels are referred to herein as a topmost label, an underlying label directly beneath the topmost label, and a lowermost label. For example, referring to FIG. 1, the tab portion 28 of a topmost label 12a is positioned above the main portion 26 of an underlying label 12b, and the main portion 26 of the underlying label 12b is positioned above the tab portion 28 of a lowermost label 12c. Typically, the main portion of each label is larger than the tab portion of the label. An illustrative example of padded labels suitable for use in the present invention is disclosed in US Patent Application Publication No. 2010/0116425 A1.

In an exemplary embodiment, the main portion of each label in the pad of labels is writable. That is, indicia may be applied to the first major face of the label by any suitable means. The first major face of a label may be adapted to be written on by hand, such as with a pen, pencil, marker, or other instrument and may be written on as the topmost label in a pad of labels, written after the label has been dispensed, or after the label has been adhered to a desired location on the substrate to which it is applied. The label may provide a rewritable, or erasable surface, such that a label may be written on, erased, and subsequently written on again as desired. A label according to the present invention may also be written upon by selected imaging technology, such as through a printer, thermal dye transfer, or the like.

Other embodiments of padded self-stick labels may be used in a label dispenser assembly according to the present invention. For example, a pad of labels for use in the label dispenser assembly includes a second major face substantially completely covered with adhesive. In order to provide a tab portion for use in accordance with the invention, a small liner may be provided on an edge portion of the adhesive of each overlying label. Prior to application to a substrate, the release liner is removed such that the label may be securely bonded to the substrate. Such embodiments are considered to be linerless labels because the major portion of the adhesive of each overlying label is in contact with and adhered to the front face of an underlying label in the pad. In yet another exemplary embodiment, a stand-off or stilt material may be coated on the adhesive along an edge to detackify or lessen the strength of adhesion to the underlying label so as to provide a tab portion.

In another exemplary embodiment, a differential or gradient low adhesion backsize or release agent may be applied along an edge portion of the face surface of each underlying label.

In another exemplary embodiment, an end of each self stick label may be embossed to allow easy release from the next, i.e., underlying, label.

Selection of the material to be used as sheets of labels of the invention may be made based upon the environment or application for which the labels are intended to be used and the adhesive to be used, for example. In an exemplary embodiment, the sheet material may be made of or include one or more of paper, plastic films, metallic laminates, or the like.

The adhesive may be made of or include any suitable adhesive. In an exemplary embodiment, the adhesive may be a pressure sensitive adhesive. The adhesive may be selected by consideration of the intended application of the label, such as the conditions under which the label will be applied, and the materials to which the label is intended to adhere to. For example, an adhesive may be selected that is adapted to adhere the label to a surface that includes or is made of plastics, woods, metals, paper, or other materials. The adhesive may also be selected depending on the characteristics of the sheet material, and whether the label will be applied by machine or hand.

In an exemplary embodiment, the adhesive adheres more strongly to the second major face of the sheet of the topmost label than to the first major face of the sheet of the underlying label. Preferably, no adhesive remains on the first major face of the sheet of the underlying label when the topmost label is dispensed. The main portion of each label in the pad of labels may be writable. 15. The main portion of the topmost label may be substantially exposed such that the topmost label may be written on while accommodated in the label dispenser.

FIG. 2 illustrates an exemplary embodiment of a label dispenser apparatus according to the present invention. The label dispenser apparatus 200 is adapted for individually dispensing labels from a pad (not shown) operationally seated in the dispenser and includes a support surface 210 having first remote end 211 and second remote end 212, first retention member 221 and second retention member 222. The first and second retention members 221 and 222 are rotatably accommodated at the first and second remote ends 211 and 212 of the support surface 210. That is, the first and second retention members may rotate as shown by the direction of rotation 213. The first and second retention members 221 and 222 include contact edges 223. The contact edges 223 of the first and second retention members 221 and 222 are urged towards the first surface 210 by impetus of tensioning mechanisms, e.g., first and second springs in the embodiment shown, such that the contact edges 223 of the first and second retention members 221 and 222 exert a force towards the support surface 210.

The support surface may be a substantially continuous substantially planar surface or a combination of structures that define a support, e.g., an array of two or more rails, posts, etc. whose tops define a plane on which the pad is supported.

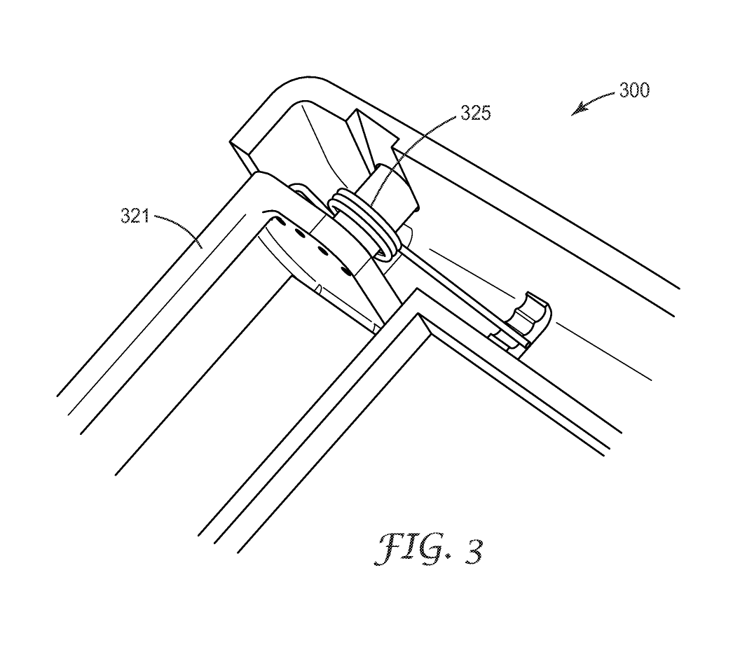

The tensioning mechanisms may be any suitable elastic or resilient element that urges the contact edges 223 of the first and second retention members 221 and 222 towards the support surface 210. Illustrative examples of suitable tensioning mechanisms include springs, e.g., coil or torsion springs, etc. made of suitable plastic or metal, and elastic bands, etc., living springs (sometimes referred to as living hinges) incorporated into the first and/or second retention members or another portion of the label dispenser apparatus, etc. In an exemplary embodiment, the first and second springs are torsion springs. FIG. 3 illustrates the underside of an exemplary embodiment of a label dispenser apparatus 300 according to the present invention. Spring 325 is positioned on the retention member 321 such that a contact surface of the retention member is urged towards the support surface of the label dispenser apparatus.

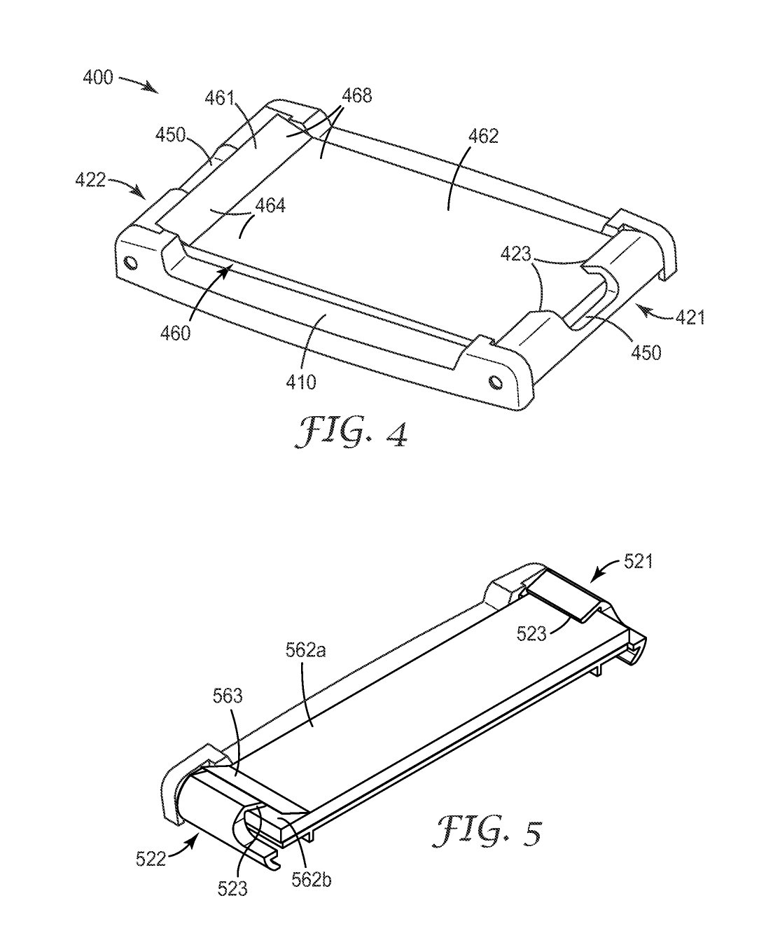

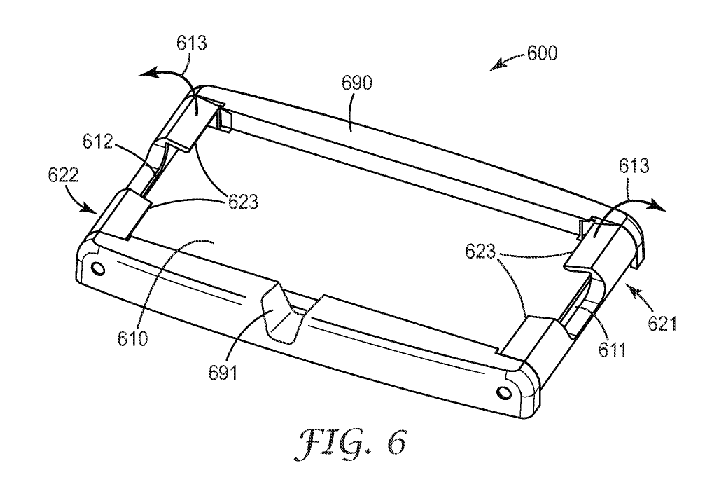

The support surface 410 of the label dispenser assembly 400 may accommodate a pad of labels 460, e.g., as illustrated in FIG. 4. In an exemplary embodiment, the support surface 410 is substantially rectangular and surrounded at four corners by four features extending in a direction transverse to the support surface 410 that rotatably accommodate the first and second retention members 421 and 422 and respective first and second springs.

The shape of the support surface 410 and associated walls may correspond to any suitable shape of a pad of labels. In an exemplary embodiment, the support surface 410 includes a square or rectangular portion to accommodate a square or rectangular pad of labels. In another embodiment, the support surface may include curved portions or portions having a recognizable shape to accommodate various shapes of pads of labels.

In an exemplary embodiment, the pad of labels 460 includes a plurality of labels arranged in a stack, each label having a sheet 468 with a tab portion 461, a main portion 462, a first major face 464, and a second major face opposite the first major face 464.

A pad of labels may be loaded into the label dispenser assembly of the present invention by rotating the first and second retention members 421 and 422 away from the support surface 410. The pad of labels 460 is then positioned on the support surface, and the first and second retention members 421 and 422 are released. The tensioning mechanisms thereupon urge the contact edges 423 of the first and second retention members 421 and 422 towards the support surface 410, thereby exerting a force on the pad of labels 460, holding the pad of labels 460 securely in place. The pad is preferably arranged such that the tab portion of the topmost label extends through the dispensing channel.

Those skilled in the art will be able to readily configure label dispenser assemblies of the invention for desired applications. Typically it will be preferred that the support surface be at least as large as the dimensions of the labels such that the stack or pad can be operationally seated therein in substantially flat form. In the case of embodiments wherein the labels comprise a perforation line separating the tab portion and main portion, the separation strength of the line should be sufficiently high that the top most label can be removed from the underlying label, i.e., overcoming the adhesion between the top most label and underlying label, without separating the tab portion.

One or both of the first and second retention members 421 and 422 may include an optional depression 450, such as a groove, cut-out, or other feature, adapted to facilitate grasping of the tab portion of the topmost label. The tab portion 461 of the topmost label may rest above or adjacent to the second retention member 422, for example. The depression 450 allows access for grasping of the tab portion, in order to remove the topmost label from the label dispenser assembly 400. In an exemplary embodiment, the depression may further facilitate grasping the tap portion of the topmost label when it is adjacent to a retention member, for example, when it is positioned partially or completely under a retention member. The depression 450 may also facilitate manipulation of the retention member, such as facilitating rotation away from the planar first surface 410 when a pad of labels is to be loaded in the label dispenser assembly. For example, the index finger and thumb of one hand may be positioned on the depression 450 of first and second retention members 421 and 422, respectively, to rotate the first and second members away from the planar first surface 410, while the other hand is used to position a pad of labels in the label dispenser assembly 400. The first retention member is urged into contact with the main portion end of the topmost label and preferably the tab portion of the topmost label protrudes through the dispensing channel such that the second retention member is urged into contact with the label end of the next sequential label.

A label may be dispensed from a label dispenser assembly of the present invention by gripping the tab portion 461 of the top most label and pulling the tab portion 461 in a direction generally upwards and away from the second retention member 422, for example. The topmost label will subsequently be removed from beneath the first retention member 421 and through the dispensing channel. When the topmost label is removed from beneath the first retention member 421, the tab portion of the underlying label will also be pulled from beneath the first retention member 421 due to action of the adhesive on the second major face of the topmost label in contact with the first major face of the underlying label. The first retention member 421 may rotate away from the first planar surface of the label dispenser assembly while the topmost label is being dispensed. Finally, the topmost label will become completely separated from the former underlying label, and the former underlying label will become the new topmost label, preferably with its tab portion protruding through the dispensing channel and 1 rests above or adjacent to the first retention member 421, ready to be dispensed. In preferred operation, the action of dispensing the topmost label results in positioning of the tab portion of the next underlying label through the dispensing channel, presenting it to be grasped for subsequent removal. Thus, the invention provides so-called “pop-up” performance.

In the exemplary embodiment illustrated in FIG. 5, the contact edge 523 of the first retention member 521 exerts a force on the main portion 562a of the topmost label. The contact edge 523 of the second retention member 522 exerts a force on the main portion 562b of the underlying label while the tab portion 563 of the topmost label may rest above or adjacent to the second retention member 522.

The position at which the contact edge 523 contacts the pad of labels 560 may be determined based on the size of the tab portion of the labels used. In an exemplary embodiment, the contact edge 523 contacts the label at a distance from the nearest end of the label less than the width of the tab portion of the label. That is, the contact edge 523 of the second retention member 522 applies force at an area on the underlying label directly below a portion of the topmost label which is uncoated with adhesive. If the contact edge 523 is positioned to apply force at a point beyond the weakened separation line, for example, the tab portion of the topmost label will likely be folded under the contact edge 523 of the second retention member 522 rather than positioned above or adjacent to the second retention member 522, and thus will not be positioned for easy grasping.

The adhesive of the last or lower most label, for example, in a pad of labels may engage a release liner (not shown) which may be removed prior to installation into a label dispenser assembly of the present invention. The pad of labels is then removably adhered to the label dispenser assembly to assist in securing the pad of labels to the label dispenser assembly. In another exemplary embodiment, a stiff backcard that remains with the pad underlying the bottom most label when loaded in a label dispenser assembly is used. Due to the increased stiffness provided by a stiff backcard, the pad of labels remains secured in place by the retention members rather than bending and subsequently sliding out from under the retention members when attempting to dispense a label. Such bending could result in the entire pad being dispensed from the label dispenser assembly rather than only a single label, damage to the pad of labels, and/or damage to the label dispenser assembly.

In another exemplary embodiment, a label dispenser assembly 600 further includes a plurality of side walls 690 adjacent, and extending in a direction transverse, to the first surface 610. The plurality of side walls 690 form a recess in which a pad of labels may be accommodated. A label dispenser assembly having a plurality of side walls may include a cut-out portion 691 which allows observation of the height of a pad of labels accommodated in the label dispenser assembly. That is, the cut-out portion 691 allows a determination of when all labels in the pad of labels will be dispensed, and a new pad will need to be loaded in the label dispenser assembly.

A label dispenser assembly according to the present invention can be made from a variety of suitable materials. In an exemplary embodiment, the label dispenser assembly is made substantially from polycarbonate. Other exemplary materials include plastics having sufficient rigidity and durability to accommodate and individually dispense labels arranged in a pad. The label dispenser assembly can be manufacture using a variety of suitable methods for the selected material. For example, injection molding techniques can be used to manufacture some embodiments.

In addition to the aforementioned benefits of individual features of the label dispenser assembly, the label dispenser assembly of the present invention includes several benefits. By providing a rotatable retention member, the risk of labels being torn or otherwise damaged when dispensed is minimized, even when a label is dispensed in a direction beyond perpendicular to the pad of labels. Rather than tear, the label will cause the retention member to rotate such that the label may be dispensed. Furthermore, a rotatable retention member facilitates loading of the label dispenser assembly. The retention members can simply be rotated to allow positioning of the pad of labels in the label dispenser assembly, rather than requiring manipulation of a pad of labels by bending to slide under a fixed retention member, for example.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom. Each patent and patent application cited herein is incorporated by reference in its entirety.

What is claimed is:

1. A label dispenser apparatus for individually dispensing labels from a pad or stack of labels arranged in the dispenser comprising:
a support surface having first and second remote ends;
first and second retention members rotatably accommodated at the first and second remote ends, each retention mechanism having a contact edge; and
a tensioning mechanism associated with the first retention member and a tensioning mechanism associated with the second retention member;
wherein the contact edges of the first and second retention members are urged towards the support surface by the first and second tensioning mechanisms, respectively, such that the contact edges of the respective first and second retention members each exerts a force towards the support surface.

2. The label dispenser apparatus of claim 1 wherein at least one of the first and second retention members comprises a depression adapted to facilitate grasping of a label.

3. The label dispenser apparatus of claim 1 wherein the first tensioning mechanism is selected from the group consisting of springs and elastic members.

4. A label dispenser assembly comprising the apparatus of claim 1 and further comprising a pad of labels operationally seated on the support surface wherein the first and second retention members each exerts a force on the pad of labels towards the support surface.

5. The label dispenser assembly of claim 4 wherein the pad of labels comprises a plurality of labels, each label comprising a (1) sheet having a tab portion and a main portion, the sheet having a first major face and a second major face, and (2) an adhesive on at least a portion of the second major face of the sheet; wherein the labels are arranged in a padded stack.

6. The label dispenser assembly of claim 5 wherein the pad of labels is a linerless pad of labels.

7. The label dispenser assembly of claim 5 wherein the pad of labels further comprises a topmost label, an underlying label directly beneath the topmost label, and a lowermost label, and the labels are positioned to form the pad of labels such that the tab portion of the topmost label is positioned above the main portion of the underlying label.

8. The label dispenser assembly of claim 5 wherein the adhesive adheres more strongly to the second major face of the sheet of the topmost label than to the first major face of the sheet of the underlying label.

9. The label dispenser assembly of claim 5 wherein no adhesive remains on the first major face of the sheet of the underlying label after the topmost label is dispensed.

10. The label dispenser assembly of claim 5 wherein first major surface of the main portion of each label in the pad of labels is writable.

11. The label dispenser assembly of claim 5 wherein the second major face of the tab portion of each label comprises a first portion uncoated with adhesive and a second portion coated with adhesive, and the second portion is smaller than the first portion.

12. The label dispenser assembly of claim 5 wherein the tab portion of a label is separated from the underlying label by a release liner or release agent.

13. The label dispenser assembly of claim 5 wherein the tab portion and main portion of each label are divided by a weakened separation line.

14. The label dispenser assembly of claim 4 wherein the pad of labels comprises a stiff backcard underlying the bottommost label.

15. The label dispenser assembly of claim 4 wherein the pad of labels is removeably adhered to the support surface.

16. The label dispenser assembly of claim 5 wherein the tab portion of the topmost label rests above or adjacent to the first retention member and the first retention member exerts force on the main portion of the underlying label.

17. The label dispenser assembly of claim 5 wherein the main portion of the topmost label is substantially exposed such that the topmost label may be written on while accommodated in the label dispenser.

18. The label dispenser assembly of claim 5 wherein the adhesive is adapted to removably adhere the label to a surface.

19. The label dispenser assembly of claim 5 wherein the adhesive is adapted to permanently adhere the label to a surface.

20. The label dispenser assembly of claim 5 wherein the adhesive is adapted to adhere the label to a surface made from a material selected from the group consisting of plastic, wood, metal, paper, and glass.

21. The label dispenser assembly of claim 5 wherein each label comprises a sheet comprising one or more layers selected from the group consisting of paper, foil, or plastic films.

22. The label dispenser assembly of claim 5 wherein the label comprises a multilayer sheet.

23. A method of dispensing a label, comprising the steps of:
(1) providing a label dispenser assembly that comprises a pad of labels operationally seated in a label dispenser assembly comprising:
a support surface having first and second remote ends;
first and second retention members rotatably accommodated at the first and second remote ends and having a contact edge; and
a tensioning mechanism associated with the first retention member and a tensioning mechanism associated with the second retention member;
wherein the contact edges of the first and second retention members are urged towards the support surface by the first and second springs, respectively, such that the contact edges of the first and second retention members each exerts a force towards the support surface, and the pad of labels comprises a topmost label, an underlying label directly beneath the topmost label, and a lowermost label, the labels positioned to form the pad of labels such that the tab portion of the topmost label is positioned above the main portion of the underlying label, each label comprising a tab portion, main portion, first major face and second major face and a layer of adhesive on at least a portion of the second major face, and wherein the tab portion of the topmost label rests above or adjacent to the second retention member and the second retention member exerts force on the main portion of the underlying label;
(2) gripping the tab portion of the topmost label;
(3) pulling the tab portion of the topmost label in a direction away from the label dispenser assembly such that the topmost label is removed from beneath the first retention member, the tab portion of the underlying label is removed from beneath the first retention member, and the topmost label is separated from the label dispenser assembly.

24. The method of claim 23 wherein the contact edge of the first retention member rotates away from the support surface when the label is removed from beneath the first retention member.
